(19) United States
(12) Patent Application Publication
(10) Pub. No.: US 2012/0116673 A1
(43) Pub. Date: May 10, 2012

(54) SYSTEM AND METHOD LOCATING A FUEL SUPPLY FACILITY IN RESPONSE TO A FUEL SUPPLY ALARM

(75) Inventors: Bum Tae Lee, Goyang (KR); Soon Hyeng Hwang, Seoul (KR); Chi Nam Oh, Suwon (KR); Tae Soo Kim, Seoul (KR)

(73) Assignees: KIA MOTORS CORPORATION, Seoul (KR); HYUNDAI MOTOR COMPANY, Seoul (KR)

(21) Appl. No.: 13/081,795

(22) Filed: Apr. 7, 2011

(30) Foreign Application Priority Data
Nov. 4, 2010 (KR) 10-2010-0109366

(51) Int. Cl. G01C 21/36; G06F 17/30

(52) U.S. Cl. 701/432; 707/769; 707/E17.014; 701/439

(57) ABSTRACT

A technique for locating a fuel supply facility in response to a fuel supply alarm is provided. More specifically, the technique sends a request for a search of fuel supply facilities in the vicinity of the vehicle to a vehicle information center in response to a fuel supply alarm lamp signal being generated in the vehicle. Upon receiving the request, the vehicle information center searches peripheral fuel supply facilities according to engine information and road information of the vehicle and extracts one or more fuel supply facilities that conform to a previously input condition, which are then transmitted to the vehicle and conveyed via a terminal to the user Thus, the above system cooperates with a vehicle information center to automatically search peripheral fuel supply facilities to increase efficiency and effectiveness of such systems.

### CROSS-REFERENCES TO RELATED APPLICATIONS

Priority to Korean Patent Application Number 10-2010-0109366, filed on Nov. 4, 2010, which is incorporated herein by reference in its entirety, is claimed.

### BACKGROUND OF THE INVENTION

1. Field of the Invention

The present invention relates to a system and method for providing path guidance for a fuel station based on an interworking fuel supply alarm, and more particularly, to a technique which cooperates with a vehicle information center upon turning on an fuel supply alarm lamp to search an fuel supply facility according to an engine type of a vehicle and road information, thereby guiding the nearest fuel station or charging station.

2. Description of the Related Art

In general, when a small amount of a fuel remains in a fuel tank of a vehicle, an fuel supply alarm lamp is turned on to indicate to a user that a fuel supply facility, e.g., a gas tank, needs to be refilled.

However, sometimes, due to traffic or time constraints, fuel service stations are not readily accessible in the required amount of time before the vehicle runs out of gas. For example, when a driver is traveling in a location in which they are not familiar, it may be all but impossible to find a fuel station in time before the vehicle runs out of gas.

Conventionally, in current vehicle information systems when the fuel supply alarm lamp is turned on, a user may utilize a navigational device to locate the nearest fuel supply facility. Typically, the navigation device then displays an icon regarding the fuel supply facility on a map to allow a user to select and set the fuel supply facility as a destination or stopover, thereby receiving a new or alternate path guidance.

Additionally, there are methods of manually searching a fuel supply facility using various POI searching schemes such as a point of interest (POI) search nearby current position or the cursor position, a POI search nearby the destination, and a POI search along the route in the related art.

In the conventional method mentioned above, however, a driver must perform a cumbersome procedure that attempts searching the fuel supply facility from a navigation device while driving a vehicle. In particular, because a driver searches fuel supply facilities within a particular radius based on a current location. However, this current location may be on a road which is an entry-limited road such as an expressway. When the driver is traveling on an entry limited road, the closest fuel service station may not be the closet based on driving distance because of the particular characteristics of the road, i.e., in the case of expressways there may not be an exit for 20 miles so majority of the fuel stations which show up on the search will be inaccessible.

For example, although a driver may be only interested in the fuel supply facilities/fuel stations which are in the driver's direction of travel, the navigation system would also search those fuel supply facilities behind and adjacent to the driver's direction of travel even though those fuel stations are not accessible. In this case, because the driver cannot get to the fuel supply facilities which are behind and adjacent to the driver's direction of travel, the searching efficiency is deteriorated significantly. Moreover, since the driver searches all the fuel stations/charging stations regardless of the type of fuel that is required for that particular vehicle, a searching time unnecessarily long and include more information than is required, thus deteriorating the searching efficiency even more so.

### SUMMARY OF THE INVENTION

The present invention provides a system and method for calculating path guidance for a fuel station based on an interworking fuel supply alarm that automatically searches peripheral fuel stations or charging stations based on the current location of the vehicle according to engine information for that particular vehicle and road information over which the vehicle is traveling when the fuel supply alarm lamp is turned on.

In accordance with an aspect of the present invention, a technique for calculating route guidance to a fuel supply facility in response to a fuel supply alarm is provided. More specifically, the technique begins by sending a search request to a vehicle information center to locate a fuel supply facility (e.g., fuel station) when a fuel supply alarm lamp signal of a vehicle is generated. In response to receiving the request, the vehicle information center then searches a database for peripheral (in relation to the direction of travel of the vehicle) fuel supply facilities according to engine information associated with that specific vehicle and current road characteristics. Based on these factors/previously input conditions, the nearest one or more conforming fuel supply facilities are extracted from the database by the vehicle information center; and transmitted to the vehicle. Upon receiving the one or more conforming fuel supply facilities at the vehicle, a specific sound is output by an audio terminal of the vehicle and the locations of the one or more conforming fuel supply facilities are conveyed to the driver via, e.g., a display or audio guidance/notification.

The above technique may also include an option to set one or more conditions which may be used by the vehicle information center in locating conforming fuel supply facilities. For example, the user may optionally chose, upon locating a conforming fuel supply facility, to set the conforming fuel supply facility as a destination/stopover in an already calculated path guidance via, e.g., the audio terminal or an interactive display.

Furthermore, in some embodiments of the present invention the extraction of the conforming fuel supply facility may also include selecting either a fuel/gas station or a charging station from a list of conforming fuel supply facilities found according to the engine information of the vehicle.

In addition, in other embodiments of the present invention, the technique can also determine whether is the vehicle is currently traveling on a general road or on an expressway and qualify the results accordingly. For example, if the vehicle is currently on an expressway, the vehicle information system would then analyze a database for upcoming entry and exiting locals as well as rest stops on the expressway. Then based on these locals, the nearest possible fuel station or charging station is determined, extracted and transmitted to the vehicle to be conveyed to the user. Accordingly, the present invention allows the user to specify searching criteria such as station type, name, distance information, direction information, cost information, or path information.

In accordance with another aspect of the present invention, the technique may alternately request a connection with a consultant when a fuel supply alarm lamp signal is generated and receive an input of one or more searching conditions for a fuel supply facility by the consultant in response to a request to locate a fuel supply facility by a user. In response to the input, peripheral fuel supply facilities are searched according to engine information of a vehicle, road information, and the one or more searching conditions and the results are transmitted accordingly to the vehicle. Upon receiving these results, the vehicle conveys these results to the user via, e.g., an audio terminal of the vehicle or a display.

In some other embodiments, the technique may also include calculating a path to a fuel supply facility to be conveyed via, e.g., an audio terminal or display, when the audio terminal receives a request for route/path guidance to a fuel supply facility in accordance with the searched results. Thus, the system may also be configured to manually search for peripheral fuel supply stations even when the fuel supply alarm lamp is not on via a user command.

Accordingly, the present invention cooperates with a vehicle information center to automatically search peripheral fuel supply facilities based on the vehicle's current location according to engine information related to that particular vehicle and current road information when a fuel supply alarm lamp is turned on. Accordingly, this technique provides the user with route guidance to more appropriate fuel supply facilities and thereby increases convenience of the overall system to a user.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a system for providing route guidance to a fuel supply facility in response to a fuel supply alarm according to an exemplary embodiment of the present invention; and

FIG. 2 is a flowchart illustrating a method providing route guidance to a fuel supply facility in response to a fuel supply alarm according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

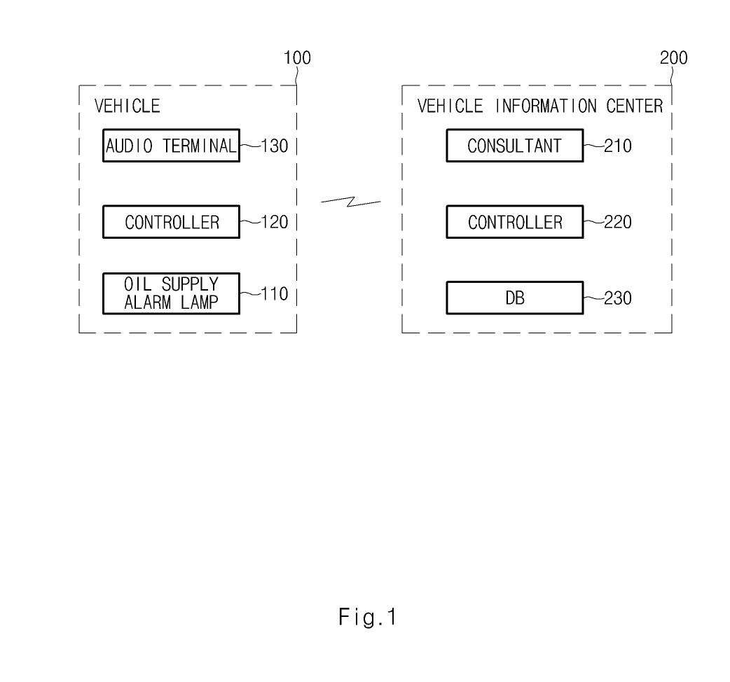

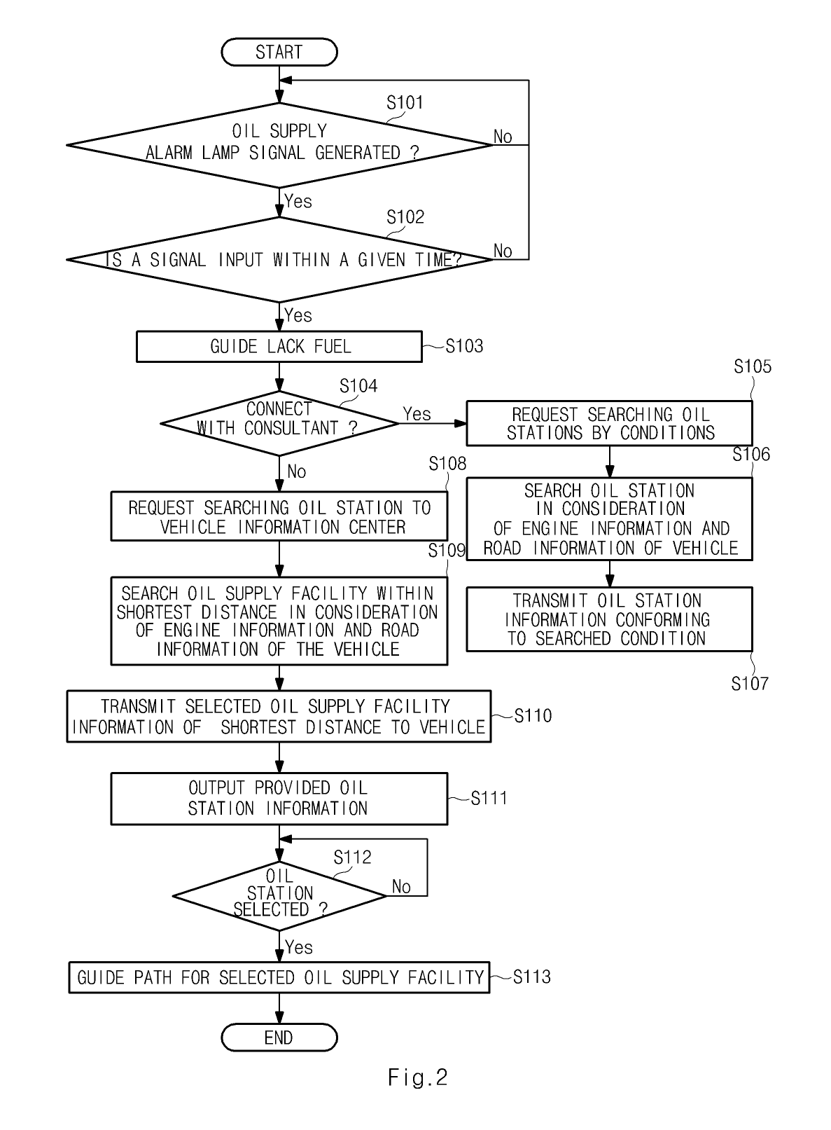

Hereinafter, a technique for providing path guidance to a fuel supply facility (e.g., a fuel station or a charging station) in response to a fuel supply alarm according to an embodiment of the present invention will be described with reference to FIG. 1 and FIG. 2 in detail.

FIG. 1 is a block diagram illustrating a configuration of a system for determining and calculating route guidance to a fuel supply facility in response to a fuel supply alarm according to an embodiment of the present invention.

In the illustrative embodiment of the present invention, the system is generally made up of a vehicle 100 and a vehicle information center 200. More specifically, however, the vehicle 100 includes a fuel supply alarm lamp 110, a controller 120, and an audio terminal 130. In order to determine whether the fuel in a vehicle is low, the controller 120 checks a residual fuel amount in a fuel tank in units of given periods of time. When the residual fuel amount in the fuel tank is less than or equal to a reference amount, the controller 120 generates a fuel supply alarm lamp signal, which is then sent to the fuel supply alarm lamp 110. When the fuel supply alarm lamp 110 receives a fuel supply alarm signal from the controller 120, the fuel supply alarm lamp is turned on.

Furthermore, the terminal 130 is configured to receive input destination from a driver/user, and provide the user with route guidance to the destination via an audio output or visual output. For example, the term ail 130 may be an audio terminal which give and receives commands via an audio output. Alternatively, the terminal 130 may also be a display which can both output directions to a user via both audio and visual display. More specifically, the terminal 130 is provided to guide a user to a fuel supply facility provided from the vehicle information center 200. The terminal 130 may also be used to set a selected fuel supply facility input by the driver as stopover or the destination to which a driver is guided via, e.g., an audio output.

The vehicle information center 200 may include a consultant 210, a controller 220, and a database 230. When the consultant 210 receives a consulting request through the terminal 130 and a call connection is achieved, the consultant filters the located fuel supply facilities in the vicinity of the vehicle based on conditions set by the user and inputs the conditions for searching the fuel station in the controller 220.

The controller 220 then searches for one or more fuel supply facilities according to engine information of a vehicle, road information of a current vehicle location, and the specific conditions set by the user. When the conditions are not input, the controller 220 searches the fuel supply facility located within the shortest peripheral distance based on the vehicle's engine type and the type of road which the vehicle is traveling on and transmits the searched one or more fuel supply facilities to the vehicle 100.

In searching for a particular fuel supply facility, the system accesses and analyzes a database 230 which may include, fuel supply facility searching data, peripheral road information of a fuel supply facility, peripheral road entry information of the fuel supply facility (e.g., entrance and exit ramps for an expressway), and fuel cost by fuel supply facilities.

Hereinafter, a method for determining and calculating route guidance to a fuel supply facility in response to a fuel supply alarm according to an embodiment of the present invention will be described with reference to FIG. 2 in detail.

In the illustrative embodiment of the present invention, the controller 120 checks a residual fuel amount in a fuel tank in units at given periods time. When the residual fuel amount in the fuel tank is less than or equal to a reference amount, the controller 120 generates a fuel supply alarm lamp signal to control the fuel supply alarm lamp 110 to be turned on.

At this time, the controller 120 checks whether a fuel supply alarm lamp signal is generated (S101). When the fuel supply alarm lamp signal is generated, the controller 120 checks whether the fuel supply alarm lamp signal is a signal input within a given time (S102). In this case, when the fuel supply alarm lamp signal is again generated within, e.g., two hours, after initial generation, the controller 220 disregards it.

Subsequently, the controller 120 can then also be configured to output an audio signal to the terminal 130 to indicate to the user that the fuel in the vehicle is below a predetermined level (S103). In addition, the system may be also configured to check whether a driver has attempted to connect with a consultant (S104).

When the user attempts to connect with the consultant, the terminal 130 connects a call with the consultant 210 through a wireless communication network, and the consultant 210 receives a request for searching fuel supply facilities based on conditions set by the user. The consultant then inputs corresponding conditions in the controller 220 (S105). For example, user defined conditions may include but are not limited to particular brands of fuel (e.g., Hess, Sunoco, Mobile, etc.), fuel costs, a max distance to a fuel facility, etc. In the forgoing illustrative embodiments a consultant may be either a human or a computer operated system which automatically interpolates and inputs the data accordingly.

Accordingly, the controller 220 cooperates with the database 230 and searches for fuel supply facilities which conform to conditions set by the user while at the same time taking into account engine information and road information of the user's vehicle (S106). In this case, the engine information and road information of a vehicle may include for example information regarding whether the vehicle is a diesel vehicle, a gasoline vehicle an electric, or any other type of fuel station which provides a specific type of fuel for that particular vehicle, and information regarding whether the vehicle is traveling a general road or an expressway at that current point in time. The foregoing information is collected upon receiving the search request via communication with the terminal 130.

Based on the received information received from the vehicle, the controller 220 sets a type of an fuel supply facility (e.g., general fuel station, charging station, hydrogen station, electric charging station, etc.) to be searched according to an engine type of a current vehicle, and checks whether a current location is a general road or a expressway.

When the current location is the general road, the controller 220 searches fuel supply facility information according to engine types of vehicles positioned within a given distance from a periphery of the driver's vehicle (in the direction in which the vehicle is currently traveling). In this case, a searching radius is preferably controlled in consideration of country and regional characteristics.

Alternatively, when the current location is the expressway, although a fuel supply facility nearest to the current location is selected, entry/exit points on the expressway are additionally determined due to characteristics on an expressway. This is because a fuel supply facility may be relative close to the vehicle and in its direction of travel, however, that particular facility is significantly difficult to reach because of the characteristics of the expressway, e.g., the distance to the exit ramp. Consequently, in this situation, a fuel supply facility is searched based on points of entry and exit of the expressway, rest areas, and termination points along the expressway. For example, a one or more fuel supply facilities may be searched which correspond to interchanges and rest areas, for example, 50 kms in the peripheral/direction of travel on a reference road of a current location of the vehicle. Furthermore, the system may also further limit the search to those fuel supply facilities which are in a peripheral radius of about, e.g., 5 km of an interchange entry point, and located at a rest stop/area, or those a fuel supply facilities in a periphery radius of about, e.g., 5 km, of an expressway termination point.

In the present invention, entry information related to rest areas or particular expressway/highways is previously stored by the controller 220 in the database 230. The controller 220 can then determine one or more fuel supply facilities which are accessible to the vehicle based on rest stops and entry/exit locations of an expressway using the entry information of that particular road. Thus, when a user is provided with only those facilities that are in their peripheral direction of travel and not those facilities which are either inaccessible that that particular point due to the type of road which the vehicle is on or those facilities which are in the user's opposite direction of travel.

Moreover, the controller 220 can check whether there is a resting area, an interchange, or an exit within a specific peripheral radius (e.g., 50 km) of the current location of the vehicle. When there is no resting place, IC, or exit, the controller 220 can then expand the radius thereof and search alternate peripheral (e.g., at a searching a zone up 100 km).

Once one or more facilities have been located which conform those specific conditions, the controller 220 transmits facility information conforming to the search conditions to the vehicle 100 via a wireless scheme (S107). For example, when one or more supply facilities in a periphery radius of about 10 km from the current location are located and a driver has set conditions for the facility according to fuel costs, the controller 220 extracts and transmits fuel station information with the lowest fuel cost among them to the vehicle 100.

When the driver does not attempt to connect with the consultant in S104, the terminal 130 may also be configured to automatically request a search for a one or more fuel supply facilities to the vehicle information center 200 through a wireless communication network (S108).

Accordingly, the controller 220 of the vehicle information center 200 cooperates with a database 230 to locate one or more fuel supply facilities which are closest to the vehicle based on engine information and road information of the vehicle (S109). Additionally, the user may also filter the results based on fuel station/charging station type, name of facility, distance information, direction information, cost information or path information.

The control unit 220 then transmits information related to one or more selected fuel supply facility information based on the conditions set by the user, the engine type and the specific road conditions on which the vehicle is currently traveling (S110). Upon receiving this information, the terminal 130 of the vehicle 100 outputs the fuel facility information via, e.g., a sound or visual display, or both (S111). Once the user makes a selection of the their preferred fuel supply facility (S112), the terminal then calculates/guides a path to the selected fuel supply facility and conveys the calculated path to the user via, e.g., audio output or a visual display (S113).

Furthermore, as noted above, the controller 220 may set locate specific types of fuel supply facilities (e.g., general fuel station, charging station, hydrogen charging station, electric charging station, etc.) according to an engine type of a current vehicle, and also determine whether the vehicle is currently traveling on a general purpose road or an limited access road, e.g., an expressway.

When is a general road, the controller 220 searches fuel supply facility information according to the engine type of vehicle within a given distance from a periphery of the user's vehicle. In this case, a searching radius is preferably controlled in consideration of country and regional characteristics. For example, the controller 220 searches a fuel station in a periphery radius 10 km of a current location and extracts and transmits fuel supply facility information nearest to the current location among them to the vehicle 100 (i.e., locates facilities in the vehicles direction of travel.

Advantageously, the present invention allows a user to locate fuel supply facilities in a more efficient and effective manor than those technique currently known in the art.

In addition, the present invention may also be implemented as a computer readable media stored in a recording medium that is readable and executed by a processor. The recording medium readable by the processor can include, for example, a ROM, a RAM, a CD-Rom, a magneto-optical disk, a floppy disk or an optical data storage device.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for providing route guidance for a fuel supply facility in response to a fuel supply alarm, comprising:
sending a request, by a first controller, for a search of one or more fuel supply facilities to a vehicle information center in response to a fuel supply alarm lamp signal of a vehicle being generated;
searching, by a second controller, peripheral fuel supply facilities according to engine information and road information of the vehicle;
extracting, by the second controller, one or more fuel supply facilities conforming to a previously input condition by the vehicle information center;
transmitting, by the second controller, the extracted one or more fuel supply facilities conforming the previously input conditions to the vehicle; and
conveying, by a terminal within the vehicle, a result identifying the fuel supply facilities conforming to the previously input conditions to the user.

2. The method of claim 1, further comprising setting the fuel supply facility conforming to the condition as a destination for route guidance by the terminal.

3. The method of claim 1, wherein extracting the fuel supply facility comprises:
selecting the type of fuel supply facility according to the engine information of the vehicle;
checking whether the vehicle is currently on a general road or an expressway;
analyzing rest area entry information in response to determining the that vehicle is currently on an expressway;
searching possible expressway entry/exit locations and associated fuel supply facilities located near the entry/exit locations nearest to the current location; and
extracting one or more a fuel supply facilities conforming to the previously input conditions among the searched fuel supply facilities.

4. The method of claim 1, wherein the one or more conditions are selected from a group consisting of a fuel station/charging station type, a name, distance information, direction information, cost information, and path information.

5. A method for locating fuel supply facility in response to a fuel supply alarm, comprising:
requesting a connection with a consultant in response to a fuel supply alarm lamp signal being generated;
receiving one or more searching conditions input for filtering out one or more fuel supply facilities in response to a search request from the user for a fuel supply facility;
searching peripheral fuel supply facilities according to engine information of a vehicle, road information, and one or more searching conditions;
transmitting a search result to the vehicle; and
conveying the search result to the user via a terminal within the vehicle.

6. The method of claim 5, further comprising calculating a path to the fuel supply facility to be conveyed to the user via the terminal in response to the terminal receiving, from the user, a request for route guidance to a selected fuel supply facility according to the searched result.

7. The method of claim 5, wherein the one or more conditions are selected from a group consisting of fuel station/charging station type, a name, distance information, direction information, cost information, and path information.

8. The method of claim 5, wherein extracting the fuel supply facility comprises:
selecting the type of fuel supply facility according to the engine information of the vehicle;
determining whether the vehicle is on a general road or a limited access highway;
analyzing rest areas and possible entry/exit points on the expressway which are which are closest to the vehicle in response to a determination that the vehicle is on a limited access highway; and
extracting a fuel supply facilities conforming to the one or more conditions among the searched fuel supply facilities.

9. A system for providing a location of a fuel supply facility in response to a fuel supply alarm, comprising:
a controller in a vehicle configured to send a request for a search of one or more fuel supply facilities to a vehicle information center in response to a fuel supply alarm lamp signal of a vehicle being generated;
a controller in the vehicle information center configured to search a database for peripheral fuel supply facilities according to engine information and road information of the vehicle, extract one or more fuel supply facilities conforming to a previously input condition, and transmit the extracted one or more fuel supply facilities conforming the previously input conditions to the vehicle; and
a terminal within the vehicle configured to convey a search result identifying the fuel supply facilities conforming to the previously input conditions to the user.

10. The system of claim 9, wherein the terminal is further configured to set the fuel supply facility conforming to the condition as a destination for route guidance by the terminal.

11. The system of claim 9, wherein the controller of the vehicle information center is further configured to select the type of fuel supply facility according to the engine information of the vehicle, determine whether the vehicle is currently on a general road or an expressway, analyze rest area entry information when the vehicle is currently on an expressway, search possible expressway entry/exit locations and associated fuel supply facilities located near the entry/exit locations nearest to the current location, and extract one or more a fuel supply facilities conforming to the previously input conditions among the searched fuel supply facilities.

12. The system of claim 9, wherein the one or more conditions are selected from a group consisting of a fuel station/charging station type, a name, distance information, direction information, cost information, and path information.

13. The system of claim 9 wherein the terminal is an audio terminal that conveys the results to the user via an audio output.

14. The system of claim 9 wherein the terminal is a display terminal that conveys the results to the user via visual output.

15. The system of claim 9 wherein the terminal is a terminal that conveys the results to the user via visual output and audio output.
